(19) United States
(12) Patent Application Publication
(10) Pub. No.: US 2022/0250122 A1
(43) Pub. Date: Aug. 11, 2022

(54) CLEANING CHAMBER AND CLEANING APPARATUS

(71) Applicant: BEIJING NAURA MICROELECTRONICS EQUIPMENT CO., LTD., Beijing (CN)

(72) Inventors: Hongjiao ZHANG, Beijing (CN); Aibing LI, Beijing (CN)

(21) Appl. No.: 17/609,711

(22) PCT Filed: Apr. 15, 2020
(86) PCT No.: PCT/CN2020/084927

§ 371 Date: Nov. 8, 2021

(30) Foreign Application Priority Data
May 8, 2019 (CN) 201910381668.8

(51) Int. Cl. B08B 9/032; B08B 3/02; B08B 13/00; B08B 3/08; F26B 21/00

(52) U.S. Cl. CPC B08B 9/0325; B08B 3/022; B08B 2209/032; B08B 3/08; F26B 21/004; B08B 13/00

(57) ABSTRACT

The present disclosure provides a cleaning chamber and a cleaning apparatus, including a chamber body and a carrying device and a spray device arranged in the chamber body. The carrying device is configured to carry the to-be-cleaned object. The spray device is arranged above and around the carrying device and configured to spray a cleaning fluid to the to-be-cleaned object. With the cleaning chamber and the cleaning apparatus provided by the present disclosure, the usage of the cleaning fluid may be reduced to reduce the cleaning cost.

### TECHNICAL FIELD

The present disclosure generally relates to the semiconductor manufacturing field and, more particularly, to a cleaning chamber and a cleaning apparatus.

### BACKGROUND

At present, in a silicon wafer diffusion process, the silicon wafer is first placed in a quartz boat, and then the quartz boat containing the silicon wafer is placed into a quartz tube. In a high-temperature diffusion furnace, a gas including a diffusion source is introduced from a tail of the quartz tube. Under a high-temperature condition, the diffusion process is completed through a chemical reaction between the gas including the diffusion source and the silicon wafer. However, after each diffusion process, the surfaces of the quartz boat and the quartz tube will retain particles after the corresponding diffusion process. If the quartz boat and the quartz tube are reused without cleaning, the cleanliness and yield of the silicon wafer will be negatively impacted.

In the prior art, a horizontal cleaning apparatus is configured to clean the quartz boat and the quartz tube. The cleaning apparatus includes a process tank and a water tank. The process tank contains a cleaning solution, and the water tank contains water. The used quartz boat and quartz tube are placed in the process tank, such that the quartz boat and quartz tube are soaked in the cleaning solution to remove the particles remaining on the quartz boat and quartz tube. Then, the quartz boat and the quartz tube are placed into the water tank, such that the quartz boat and the quartz tube are soaked in water to remove the cleaning solution remaining on the quartz boat and the quartz tube. Finally, the quartz boat and the quartz tube are removed from the horizontal cleaning apparatus. The quartz boat and the quartz tube are manually dried by blowing air to remove the water remaining on the quartz boat and the quartz tube. Thus, the cleaning of the quartz boat and the quartz tube is completed.

However, in the prior art, since the quartz boat and the quartz tube are immersed in the cleaning solution to remove the particles remaining on the quartz boat and the quartz tube. Thus, in the cleaning process, a large amount of the cleaning solution is used, which results in a relatively high cleaning cost.

### SUMMARY

The present disclosure aims to solve at least one of the technical problems existing in the prior art and provides a cleaning chamber and a cleaning apparatus, which can reduce a consumed amount of cleaning fluid and reduce cleaning cost.

To achieve the objective of the present disclosure, the present disclosure provides a cleaning chamber, which includes a chamber body and a carrying device and a spray device arranged in the chamber body.

The carrying device is configured to carry a to-be-cleaned object.

The spray device is arranged around the carrying device and configured to spray a cleaning liquid to the to-be-cleaned object.

Preferably, the spray device includes a fluid pipeline and at least one nozzle connected to the fluid pipeline. The fluid pipeline is configured to provide the cleaning fluid to the nozzle. The nozzle is configured to spray the cleaning fluid to the to-be-cleaned object.

Preferably, the spray device includes a plurality of nozzles, which are divided into at least an upper nozzle, at least a side nozzle, and at least a lower nozzle according to the positions of the sprays heads. The upper nozzle is arranged on a top of the chamber body and configured to spray the cleaning fluid downward. The lower nozzle is arranged at a bottom of the chamber body and configured to spray the cleaning fluid upward. The side nozzle is arranged around the carrying device and is configured to spray the cleaning fluid toward the to-be-cleaned object.

Preferably, the side nozzles are divided into a set of nozzle group or a plurality of sets of nozzle groups surrounding the carrying device. A plurality of nozzles of each set of nozzle group are arranged at intervals in a vertical direction.

Preferably, the cleaning chamber further includes an angle adjustment mechanism, which is configured to adjust a spray angle of the side nozzles.

Preferably, the cleaning fluid includes a chemical solution, pure water, or a dry gas.

Preferably, the cleaning chamber includes a plurality of fluid pipelines. A first pipeline including at least one of the plurality of fluid pipelines is configured to transport the chemical solution. A second pipeline including at least one of the plurality of fluid pipelines is configured to transport the pure water or the dry gas. The first pipeline is connected to at least one of the nozzles. The second pipeline is connected to at least one of the nozzles.

Preferably, the cleaning chamber further includes a liquid storage device, which includes a liquid storage tank arranged at the bottom of the chamber body and a liquid transport pipeline connected to the liquid storage tank and the fluid pipeline. The liquid storage tank is configured to recycle the liquid cleaning fluid. The liquid transport pipeline is configured to transport the liquid cleaning fluid in the liquid storage tank to the fluid pipeline.

Preferably, the carrying device includes a carrying platform, a rotation platform, and a plurality of connection columns. The carrying platform is arranged at the bottom of the chamber body and is configured to carry the to-be-cleaned object in the vertical direction. The rotation platform is arranged at the top of the chamber body opposite to the carrying platform. The rotation platform is connected to the carrying platform through the plurality of the connection columns to drive the carrying platform to rotate through the plurality of connection columns.

Preferably, the cleaning chamber further includes a rotation drive mechanism, which is arranged at the top of the chamber body, connected to the rotation platform, and configured to drive the rotation platform to rotate.

The present disclosure also provides a cleaning apparatus, including an apparatus body, and an instrument area, a control module, and a plurality of the above-mentioned cleaning chambers arranged in the apparatus body. Each of the cleaning chambers is configured to clean the to-be-cleaned object. The instrument area is electrically connected to a plurality of the cleaning chambers and configured to monitor and display parameters of a cleaning process. The control module is electrically connected to the plurality of cleaning chambers and configured to automatically control cleaning work of each of the cleaning chambers. The control module is also configured for users to perform human-machine interaction with each of the cleaning chambers.

The present disclosure includes the following beneficial effects.

The cleaning chamber provided by the present disclosure includes a chamber body and a carrying device and a spray device arranged in the chamber body. The carrying device is configured to carry the to-be-cleaned object. The spray device is arranged surrounding the carrying device and configured to spray the cleaning fluid to the to-be-cleaned object. Compared to the prior art, with the cleaning chamber provided by the present disclosure, the to-be-cleaned object are not completely immersed in the cleaning fluid when the to-be-cleaned object is cleaned. The spray device sprays the cleaning fluid to the to-be-cleaned object, which reduces the consumed amount of cleaning fluid for cleaning the to-be-cleaned object. Thus, the cleaning cost of the to-be-cleaned object is reduced.

With the cleaning apparatus provided by the present disclosure, the consumed amount of the cleaning fluid may be reduced, and the cleaning cost may be reduced with the help of a plurality of cleaning chambers provided by the present disclosure arranged in the apparatus body.

### BRIEF DESCRIPTION OF THE DRAWINGS

FIG. 1 is a schematic structural diagram of a cleaning chamber according to a first embodiment of the present disclosure.

FIG. 2 is a schematic structural diagram of a cleaning apparatus according to a second embodiment of the present disclosure.

### REFERENCE NUMERALS

11—Chamber body, 12—Fluid pipeline, 131—Upper nozzle, 132—Lower nozzle, 133—Side nozzle, 14—Liquid storage tank, 151—Rotation platform, 152—Carrying platform, 153—Connection column, 16—Rotation mechanism, 171—Instrument area, 172—Control module.

### DETAILED DESCRIPTION OF THE EMBODIMENTS

The following disclosure provides a plurality of embodiments or examples, which may be used to realize different features of the present disclosure. The specific examples of assemblies and configurations described below are used to simplify the present disclosure. These descriptions are only examples and are not intended to limit the content of the present disclosure. For example, in the following description, forming a first feature on or above a second feature may include the first and second features of some embodiments that are in direct contact with each other, and may also include an additional assembly formed between the first and second features in some embodiments, which may cause the first and second features not to be in direct contact. In addition, in the present disclosure, assembly symbols and/or labels may be reused in a plurality of embodiments. Such repetitive usage is based on the purpose of brevity and clarity, and does not represent the relationship between different embodiments and/or configurations discussed.

Furthermore, the spatially relative terms used here, such as “below,” “under,” “beneath,” “above,” “on,” and similar terms, may be used to facilitate the description of relationship between one assembly or feature relative to another or a plurality of assemblies or features shown in the drawings. In addition to the locations shown in the drawings, these spatially relative terms may further represent a plurality of locations during usage or operation of the device. When the device is placed in another position (for example, rotated 90° or in another position), these spatially relative description terms should be explained accordingly.

Although numerical ranges and parameters used to define a broader scope of the present disclosure are approximate numerical values, relevant numerical values in specific embodiments are presented here as accurately as possible. However, any value inherently inevitably contains a standard deviation due to an individual test method. Here, “about” usually means that the actual value is within plus or minus 10%, 5%, 1%, or 0.5% of a specific value or range. Alternatively, the word “about” means that the actual value falls within the acceptable standard error of the average value, depending on the consideration of those of ordinary skilled in the art to which the present disclosure belongs. It may be noted, in addition to the experimental examples, or unless otherwise specified, all ranges, quantities, values, and percentages used herein (for example, used to describe the amount of material, time length, temperature, operation conditions, quantity ratio, and other similar objectives) have been modified by “about.” Therefore, unless otherwise specified to the contrary, the numerical parameters disclosed in specification and the accompanying scope of the present disclosure are approximate values and can be changed according to requirements. At least these numerical parameters should be understood as the indicated effective number of digits and the value obtained by applying the general carry method. Here, the numerical range is expressed from one end point to the other end point or between the two end points. Unless otherwise specified, the numerical range described here includes the end points.

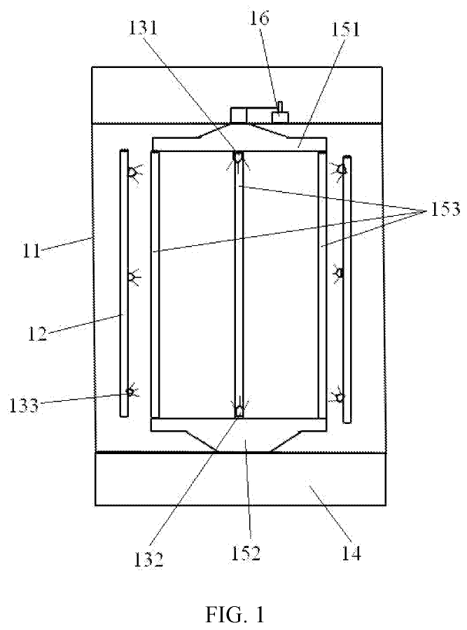

As shown in FIG. 1, embodiments of the present disclosure provide a cleaning chamber. The cleaning chamber includes a chamber body 11 and a carrying device and a spray device arranged in the chamber body 11. The carrying device is configured to carry a to-be-cleaned object. The spray device is arranged around the carrying device and is configured to spray a cleaning fluid to the to-be-cleaned object.

Compared to the prior art, with the cleaning chamber provided by embodiments of the present disclosure, the to-be-cleaned object may not be completely immersed in the cleaning fluid when the to-be-cleaned object is cleaned. The spray device may spray the cleaning fluid to the to-be-cleaned object, which reduces the consumed amount of cleaning fluid for cleaning the to-be-cleaned object. Thus, the cleaning cost of the to-be-cleaned object may be reduced.

In some embodiments, the to-be-cleaned object may include a quartz boat for carrying a wafer or a quartz tube for carrying the quartz boat.

In some embodiments, the spray device includes a fluid pipeline 12 and at least a nozzle connected to the fluid pipeline 12. The fluid pipeline 12 may be configured to provide a cleaning fluid to the nozzle. The nozzle may be configured to spray the cleaning fluid to the to-be-cleaned object.

Specifically, the fluid pipeline 12 is arranged in the chamber body 11 and connected to a cleaning fluid source for containing the cleaning fluid to transport the cleaning fluid in the cleaning fluid source to the nozzle. The cleaning spray may be sprayed to the to-be-cleaned object through the nozzle to clean the to-be-cleaned object. The fluid pipeline 12 may be connected to one nozzle or a plurality of nozzles. The fluid pipeline 12 may be connected to a plurality of nozzles to improve a spray area and a spray amount per unit time of the cleaning fluid. Thus, the cleaning efficiency may be improved.

In some embodiments, the cleaning chamber includes a plurality of nozzles, which may be divided into at least one upper nozzle 131, at least one side nozzle 133, and at least one lower nozzle 132 according to the positions of the nozzles. The upper nozzle 131 is arranged at a top of the chamber body 11 and configured to spray the cleaning fluid downward. The lower nozzle 132 is arranged at a bottom of the chamber body 11 and configured to spray the cleaning fluid upward. The side nozzle 133 is arranged around the carrying device and configured to spray the cleaning fluid toward the to-be-cleaned object.

Specifically, by using the upper nozzle 131, the side nozzle 133, and the lower nozzle 132 to spray the cleaning fluid to the to-be-cleaned object, the cleaning fluid may be sprayed toward the to-be-cleaned object from a plurality of different directions when the to-be-cleaned object is cleaned. Different positions of the to-be-cleaned object are cleaned to reduce a cleaning dead angle on the to-be-cleaned object. Thus, the cleaning effect may be improved.

In some embodiments, the upper nozzle 131 may spray the cleaning fluid downward from above the to-be-cleaned object to clean the top of the to-be-cleaned object. The lower nozzle 132 may spray the cleaning fluid upward from below the to-be-cleaned object to clean the bottom of the to-be-cleaned object. The side nozzle 133 may spray the cleaning fluid toward the side surface of the to-be-cleaned object from an outer side of the to-be-cleaned object to clean the peripheral of the to-be-cleaned object. In addition, when the reaction chamber is a reaction tube, the upper nozzle 131 and the lower nozzle 132 may spray the cleaning fluid into the reaction tube from the top tube opening and the bottom tube opening of the reaction tube, respectively, to clean the inside of the reaction tube.

In practical applications, according to the actual cleaning situation, the upper nozzle 131, the side nozzle 133, and the lower nozzle 132 may all be one or more, or one part of the upper nozzle 131, the side nozzle 133, and the lower nozzle 132 may be one or more. By increasing the quantity of the upper nozzle 131, the side nozzle 133, and lower nozzle 132, a spray area and a spray amount per unit time of the cleaning fluid may be increased. Thus, the cleaning efficiency may be improved. However, with an excessive quantity of upper nozzles 131, side nozzles 133, and lower nozzles 132, the difficulty for arranging the upper nozzles 131, side nozzles 133, and lower nozzles 132 in the chamber body 11 may be increased. Therefore, the quantity of the upper nozzles 131, side nozzles 133, and lower nozzles 132 may also need to be determined according to the actual needs.

Optionally, the side nozzles 133 may be divided into a set of nozzle groups or a plurality of sets of nozzle groups surrounding the carrying device. A plurality of side nozzles 133 of each set of nozzles may be arranged at an interval along a vertical direction.

In some embodiments, a plurality of sets of nozzle groups may be arranged around the carrying device. During the cleaning process, the quartz boat or the reaction chamber is placed on the carrying device. The plurality of sets of nozzle groups may be around the to-be-cleaned object to spray the cleaning fluid to the to-be-cleaned object from the surrounding of the to-be-cleaned object. The plurality of side nozzles 133 of each set of nozzle group may be connected to a fluid pipeline 12. Through a fluid pipeline 12, the cleaning fluid may be provided to each of the plurality of side nozzles 133 of the fluid pipeline 12. Each fluid pipeline 12 may be arranged vertically. A plurality of side nozzles 133 of each fluid pipeline 12 may be arranged at intervals along a vertical direction to spray the cleaning fluid to the side surface of the quartz boat or the reaction chamber in the vertical direction. With the plurality of sets of nozzle groups arranged around the carrying device along the vertical direction, the to-be-cleaned object may be cleaned in a peripheral direction or in an axis direction of the to-be-cleaned object. Thus, a situation of the to-be-cleaned object having a cleaning dead angle may be reduced to improve the cleaning effect. Moreover, the spray area and spray amount per unit time of the cleaning fluid may be increased to improve the cleaning efficiency.

In some embodiments, the cleaning apparatus may further include an angle adjustment mechanism, which is configured to adjust the spray angle of the side nozzle 133. The angle of the side nozzle 133 relative to the to-be-cleaned object may be adjusted by the adjustment mechanism to adjust the direction of the cleaning fluid sprayed from the side nozzle 133. Thus, the position of the cleaning fluid at the to-be-cleaned object sprayed from the side nozzle 133 may be changed. The situation of the to-be-cleaned object having the cleaning dead angle may be further reduced to improve the cleaning effect.

In some embodiment, the cleaning fluid may include a chemical liquid, pure water, or dry gas. The chemical liquid may be used to clean the contaminants on the to-be-cleaned object. The pure water may be used to pre-clean the to-be-cleaned object or/and clean the chemical liquid. The dry gas may be used to remove the water remaining at the to-be-cleaned object. With the cleaning apparatus provided by embodiments of the present disclosure, the drying gas may be sprayed onto the to-be-cleaned through the spray device. Thus, the to-be-cleaned object may be dried in the cleaning apparatus. Thus, manual drying may be avoided, which reduces the workload of the operator and improves the cleaning efficiency.

In some embodiments, the chemical liquid may include an acid liquid. The dry gas may include nitrogen.

In some embodiments, a plurality of fluid pipelines 12 are included. At least one of the plurality of fluid pipelines 12 may be as a first pipeline configured to transport the chemical liquid. In addition, at least one of the plurality of fluid pipelines may be as a second pipeline configured to transport the pure water or the dry gas. The first pipeline may be connected to at least one nozzle. The second pipeline may be connected to at least one spray head. The second pipeline may be connected to at least one nozzle.

Specifically, the chemical liquid may be transported through the first pipeline. The pure water or the dry gas may be transported through the second pipeline. Thus, the reaction of the chemical liquid and the pure water in the fluid pipeline 12 may be avoided, the cleaning effect may be improved. However, the first pipeline and the second pipeline may be connected to a same nozzle, so that one nozzle may spray the chemical liquid, the pure water, or dry gas to the to-be-cleaned object.

In some embodiments, the cleaning apparatus may further include a liquid storage device. The liquid storage device may include a liquid storage tank 14 arranged at the bottom of the chamber body 11 and a liquid transport pipeline connected to the liquid storage tank 14 and the fluid pipeline 12. The liquid storage tank 14 may be configured to recycle the liquid cleaning fluid. The liquid transport pipeline may be configured to transport the liquid cleaning fluid in the liquid storage tank 14 to the fluid pipeline 12. The cleaning fluid may be recycled by the liquid storage tank 14, and the cleaning fluid in the liquid storage tank 14 may be reused by the liquid transport tube to further reduce the consumed amount of the cleaning fluid and reduce cleaning costs.

Specifically, the liquid storage tank 14 may be a separate area arranged at the bottom of the chamber body 11. A circulation hole communicating with the liquid storage tank 14 may be arranged at the bottom of the chamber body 11. The cleaning fluid sprayed on the to-be-cleaned object may flow to the bottom of the chamber body 11 due to gravity and flow into the liquid storage tank 14 through the circulation hole. A pressure pump may be arranged at the liquid transport pipeline to pump the cleaning fluid in the liquid storage tank 14 into the fluid pipeline 12. In some embodiments, since the liquid cleaning fluid may include the chemical liquid and the pure water, a three-way valve may need to be arranged in the circulation hole. When the spray device sprays the chemical liquid, the chemical liquid may be caused to flow into the liquid storage tank 14 by the three-way valve. When the spray device sprays the water, the pure water may be discharged from the cleaning apparatus through the three-way valve to prevent the pure water from flowing into the liquid storage tank 14 to react with the chemical liquid and affect the cleaning effect of the chemical liquid. In addition, a discharge hole communicating with the outside of the cleaning apparatus may be separately arranged at the bottom of the chamber body 11. On/off valves may be arranged in the discharge hole and the circulation hole. When the chemical liquid is sprayed, the circulation hole may be opened by using the on/off valve, and the discharge hole may be closed by the on/off valve to allow the chemical liquid to flow into the liquid storage tank 14. When the pure water is sprayed, the circulation hole may be closed by using the on/off valve, and the discharge hole may be opened by the on/off valve to drain the pure water out of the cleaning apparatus.

In some embodiments, the carrying device may include a carrying platform 152, a rotation platform 151, and a plurality of connection columns 153. The carrying platform 152 may be arranged at the bottom of the chamber body 11 and configured to carry the to-be-cleaned object in the vertical direction. The rotation platform 151 may be arranged at the top of the chamber body 11 opposite to the carrying platform 152 and connected to the carrying platform 152 through the plurality of connection columns 153 to drive the carrying platform 152 to rotate through the plurality of connection columns 153.

In some embodiments, the structure of the carrying device may satisfy the ability to keep the to-be-cleaned object carried by the carrying device upright. Compared with the prior art, when the quartz boat or the quartz tube is cleaned, the quartz boat or the quartz tube is not horizontally lying in a cleaning tank, but standing upright in the chamber body 11. Thus, the length of the chamber body 11 in the horizontal direction relative to the ground may be shorter, and the length in the vertical direction relative to the ground may be longer. Therefore, the area occupied by the chamber body 11 may be reduced to facilitate the placement of the chamber body 11.

Specifically, the carrying platform 152 may be arranged at the bottom of the chamber body 11. The lower nozzle 132 may be arranged on a surface of the carrying platform 152 facing upward. The rotation platform 151 may be located at the top of the chamber body 11. The upper nozzle 131 may be arranged on a surface of the rotation platform 151 facing downward. The plurality of connection columns 153 may be vertically arranged between the rotation platform 151 and the carrying platform 152. The carrying platform 152 may be configured to carry the bottom of the to-be-cleaned object. Thus, the to-be-cleaned object may be located upright in the chamber body 11, and the to-be-cleaned object is located between the rotation platform 151 and the carrying platform 152.

As shown in FIG. 1, in some embodiments, three connection columns 153 are arranged. Both ends of each connection column 153 are connected to the rotation platform 151 and the carrying platform 152, respectively. Thus, the rotation platform 151 may drive the carrying platform 152 to rotate through the three connection columns 153. The number of connection columns 153 is not limited to this.

In some embodiments, the cleaning apparatus may further include a rotation drive mechanism 16. The rotation drive mechanism 16 may be arranged at the top of the chamber body 11 and connected to the rotation platform 151 for driving the rotation platform 151 to rotate. With the rotation drive mechanism 16, in the process of cleaning the to-be-cleaned object, the rotation platform 151 may be driven to rotate. The carrying platform 152 may be driven to rotate by the rotation platform 151, such that the to-be-cleaned object on the carrying platform 152 may rotate with the carrying platform 152. As such, the situation of the to-be-cleaned object having the cleaning dead angle may be further reduced. Thus, more positions of to-be-cleaned object may be sprayed by the cleaning fluid to improve the cleaning effect.

In some embodiments, an area for separately placing the rotary drive mechanism 16 may be arranged at the top of the chamber body 11. The rotation drive mechanism 16 may be arranged in the area and connected to the rotation platform 151. As such, the rotation drive mechanism 16 may be prevented from being corroded by the chemical liquid.

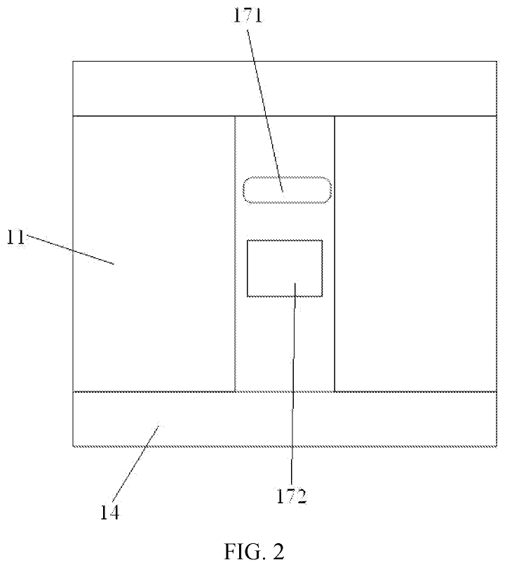

As shown in FIG. 2, embodiments of the present disclosure also provide a cleaning apparatus, including an apparatus body, and an instrument area 171, a control module 172, and a plurality of cleaning chambers provided by embodiments of the present disclosure arranged in the apparatus body. Each of the plurality of cleaning chambers may be configured to clean the to-be-cleaned object. The instrument area 171 is electrically connected to the plurality of cleaning chambers and configured to monitor and display the parameters of the cleaning process. The control module 172 is electrically connected to the plurality of cleaning chambers and configured to automatically control the cleaning process of each cleaning chamber individually and for the workers to perform human-machine interaction on each cleaning chamber separately.

The cleaning apparatus provided by embodiments of the present disclosure, with the plurality of cleaning chambers provided by embodiments of the present disclosure arranged in the apparatus body, the consumed amount of the cleaning fluid may be reduced, and the cleaning cost may be reduced.

The cleaning process of embodiments in the present disclosure is specifically described as follows. In some embodiments, the upper nozzle 131 of the chamber body 11 may be connected to the first pipeline for transporting the chemical liquids, and also connected to the pure water pipeline at the factory end. The upper nozzle 131 may be configured to spray the chemical liquid or the pure water. The lower nozzle 132 may be connected to the first pipeline for transporting the chemical liquid and also connected to the second pipeline for transporting the pure water or the dry gas. The lower nozzle 132 may be configured to spray the chemical liquid, the pure water, or the dry gas. The side nozzles 133 may be divided into two sets. One set may be connected to the first pipeline for transporting the chemical liquid and configured to spray the chemical liquid. The other set may be connected to the second pipeline for transporting the pure water or the dry air and configured to spray the pure water or the dry gas.

In the cleaning process, first, the to-be-cleaned object may be placed on the carrying device. The rotation drive mechanism 16 may be used to drive the carrying device to rotate. Meanwhile, the upper nozzle 131, the side nozzle 133, and the lower nozzle 132 that can spray the pure water may spray the pure water to pre-clean the quartz boat or the reaction chamber at the same time. After the pre-cleaning is completed, the upper nozzle 131, side nozzle 133, and lower nozzle 132 that can spray the chemical liquids may spray the chemical liquid at the same time. The rotation drive mechanism 16 may continue to drive the carrying device to rotate to clean the contaminants on the to-be-cleaned object. After the spraying of the chemical liquid is completed, the upper nozzle 131, the side nozzle 133, and the lower nozzle 132 that can spray the pure water may spray the pure water at the same time. The rotation drive mechanism 16 may continue to drive the carrying device to rotate to clean the chemical liquid remaining on the to-be-cleaned object. After the chemical liquid is cleaned, the side nozzle 133 and the lower nozzle 132 that can spray the dry gas may spray the dry gas at the same time to remove the water remaining on the to-be-cleaned object to complete a drying process. The above is a basic complete cleaning process.

In some embodiments, one or more chamber bodies 11 may be included. Each chamber body 11 may be provided with the carrying device and the spray device. Each chamber body 11 may be configured to clean the to-be-cleaned object individually. That is, when the plurality of chamber bodies 11 are arranged in the cleaning apparatus, the cleaning apparatus may simultaneously clean a plurality of to-be-cleaned objects. As such, the cleaning efficiency of the cleaning apparatus may be improved.

As shown in FIG. 2, in some embodiments, the cleaning apparatus includes two chamber bodies 11, which are arranged on the left and right sides of the tilting device, respectively. The liquid storage tank 14 is arranged below both chamber bodies 11. The cleaning apparatus also includes two rotation drive mechanisms 16. The two rotary drive mechanisms 16 are both arranged in separate areas above both chamber bodies 11 and configured to drive the carrying devices in both chamber bodies 11 to rotate, respectively. The instrument area 171 and the control module 172 are further arranged on the cleaning apparatus. The instrument area 171 may be configured to monitor compressed dry gas, nitrogen, and an exhaust pressure of the factory. The control module 172 may be configured for the workers to perform the human-machine interaction and automatic control.

In summary, with the cleaning chamber and cleaning apparatus provided by embodiments of the present disclosure, not only the usage of the cleaning fluid and the cleaning cost may be reduced, but also the occupied area of the chamber body 11 may be reduced to facilitate the placement of the chamber body 11. Moreover, the cleaning chamber and cleaning apparatus may also automatically dry the to-be-cleaned object, reduce the workload of the workers, and improve the cleaning efficiency.

1. A cleaning chamber comprising:
a chamber body;
a carrying device arranged in the chamber body and configured to carrying a to-be-cleaned object;
a spray device arranged in the chamber body, including:
a plurality of sets of nozzle groups arranged above, below, and around the carrying device, each set of nozzle groups including at least a nozzle configured to spray a cleaning fluid to the to-be-cleaned object, wherein the set of nozzle groups includes:
one or more upper nozzle arranged at a top of the chamber body and configured to spray the cleaning fluid downward;
one or more lower nozzle arranged at a bottom of the chamber body and configured to spray the cleaning fluid upward; and
one or more side nozzle arranged around the carrying device and configured to spray the cleaning fluid to the to-be-cleaned object from outside to inside; and
an angle adjustment mechanism configured to adjust a spray angle of the one or more side nozzle to clean different positions of the to-be-cleaned object from different directions.

2. The cleaning chamber according to claim 1, wherein the spray device includes:
a fluid pipeline connected to the at least a nozzle and configured to provide the cleaning fluid to the nozzle.

3. (canceled)

4. The cleaning chamber according to claim 1, wherein the one or more side nozzles are:
arranged in a column at an interval along a vertical direction; or
divided into a plurality of sets of nozzle groups arranged around the carrying device, each set of nozzle groups includes a plurality of side nozzles arranged at an interval along the vertical direction.

5. (canceled)

6. The cleaning chamber according to claim 2, wherein the cleaning fluid includes a chemical liquid, pure water, or dry gas.

7. The cleaning chamber according to claim 6, wherein the spray device includes:
a plurality of fluid pipelines including:
a first pipeline configured to transport the chemical liquid; and
a second pipeline configured to transport the pure water or the dry gas, the second pipeline being connected to a nozzle.

8. The cleaning chamber according to claim 2, further comprising:
a liquid storage tank arranged at a bottom of the chamber body and configured to recycle the liquid cleaning fluid; and
a liquid transport pipeline connected to the liquid storage tank and the fluid pipeline and configured to transport the liquid cleaning fluid in the liquid storage tank to the fluid pipeline.

9. The cleaning chamber according to claim 1, wherein the carrying device includes:
a carrying platform arranged at the bottom of the chamber body and configured to carry the to-be-cleaned object;
a plurality of connection columns; and
a rotation drive mechanism arranged at the top of the chamber body and connected to the carrying platform through the plurality of connection columns to drive the carrying platform to rotate.

10. (canceled)

11. A cleaning apparatus comprising:
an apparatus body; and
a plurality of cleaning chambers arranged in the apparatus body, each cleaning chamber being configured to clean a to-be-cleaned object and including:
a chamber body;
a carrying device arranged in the chamber body and configured to carrying a to-be-cleaned object; and
a spray device arranged in the chamber body and around the carrying device and configured to spray a cleaning fluid to the to-be-cleaned object, including:
a plurality of sets of nozzle groups arranged above, below, and around the carrying device, each set of nozzle groups including at least a nozzle configured to spray a cleaning fluid to the to-be-cleaned object, wherein the set of nozzle groups includes:
one or more upper nozzle arranged at a top of the chamber body and configured to spray the cleaning fluid downward;
one or more lower nozzle arranged at a bottom of the chamber body and configured to spray the cleaning fluid upward; and
one or more side nozzle arranged around the carrying device and configured to spray the cleaning fluid to the to-be-cleaned object from outside to inside; and
an angle adjustment mechanism configured to adjust a spray angle of the one or more side nozzle to clean different positions of the to-be-cleaned object from different directions;
an instrument area arranged in the apparatus body, electrically connected to the plurality of cleaning chambers, and configured to monitor and display parameters of a cleaning process; and
a control module arranged in the apparatus body, electrically connected to the plurality of cleaning chambers, and configured to automatically control cleaning work of each of the plurality of cleaning chambers and for workers to perform human-machine interaction on each of the plurality of cleaning chambers.

12. The cleaning apparatus according to claim 11, wherein the spray device includes:
a fluid pipeline connected to the at least a nozzle and configured to provide the cleaning fluid to the nozzle.

13. (canceled)

14. The cleaning chamber according to claim 12, wherein the one or more side nozzles are:
arranged in a column at an interval along a vertical direction; or
divided into a plurality of sets of nozzle groups arranged around the carrying device, each set of nozzle groups includes a plurality of side nozzles arranged at an interval along the vertical direction.

15. (canceled)

16. The cleaning chamber according to claim 12, wherein the cleaning fluid includes a chemical liquid, pure water, or dry gas.

17. The cleaning chamber according to claim 16, wherein the spray device includes:
a plurality of fluid pipelines including:
a first pipeline configured to transport the chemical liquid; and
a second pipeline configured to transport the pure water or the dry gas, the second pipeline being connected to a nozzle.

18. The cleaning chamber according to claim 12, further comprising:
a liquid storage tank arranged at a bottom of the chamber body and configured to recycle the liquid cleaning fluid; and
a liquid transport pipeline connected to the liquid storage tank and the fluid pipeline and configured to transport the liquid cleaning fluid in the liquid storage tank to the fluid pipeline.

19. The cleaning chamber according to claim 11, wherein the carrying device includes:
a carrying platform arranged at the bottom of the chamber body and configured to carry the to-be-cleaned object;
a plurality of connection columns; and
a rotation drive mechanism arranged at the top of the chamber body and connected to the carrying platform through the plurality of connection columns to drive the carrying platform to rotate.

20. (canceled)
